(19) United States
(12) Patent Application Publication
(10) Pub. No.: US 2013/0140939 A1
(43) Pub. Date: Jun. 6, 2013

(54) ROTOR OF ELECTRIC MOTOR AND MANUFACTURING METHOD THEREOF

(71) Applicants: Takashi Asaga, Toyota-shi (JP); Toshiya Sugiyama, Okazaki-shi (JP)

(72) Inventors: Takashi Asaga, Toyota-shi (JP); Toshiya Sugiyama, Okazaki-shi (JP)

(73) Assignee: AISIN SEIKI KABUSHIKI KAISHA, Kariya-shi, Aichi-ken (JP)

(21) Appl. No.: 13/816,806

(22) PCT Filed: Oct. 12, 2011
(86) PCT No.: PCT/JP2011/073427

§ 371 Date: Feb. 13, 2013

(30) Foreign Application Priority Data
Nov. 4, 2010 (JP) 2010-247505

(51) Int. Cl. H02K 1/18; H02K 15/02

(52) U.S. Cl. CPC H02K 1/185; H02K 15/02
USPC 310/216.129; 29/598

(57) ABSTRACT

A rotor of an electric motor comprises a rotor core composed of laminated steel plates and having pin holes; a pair of end plates having insertion holes of a diameter being greater than or equal to the diameter of the pin holes of the rotor core and arranged on opposite sides of the rotor core; and fastening members inserted into the pin holes of the rotor core, fitted in the insertion holes of the pair of end plates, and pressed by staking at opposite end portions thereof, wherein each fastening member has a body portion, main radially-expanded portions continued from the body portion and being larger in diameter than the insertion holes of the end plates, and protrusions continued from the main radially-expanded portions and protruding from the main radially-expanded portions.

### TECHNICAL FIELD

The present invention relates to a rotor of an electric motor and a manufacturing method thereof wherein a rotor core composed of laminated steel plates is fastened by fastening members.

### BACKGROUND ART

Heretofore, as rotors of electric motors of the type that a rotor core constituted by a laminated iron core is fastened by staking pins (fastening members), there has been known one described in, for example, Patent Document 1. In the rotor described in Patent Document 1, permanent magnets are inserted into magnet receiving holes provided to extend in the rotational axis direction of the rotor core, end plates are attached to opposite end portions of the rotor core, and with staking pins inserted through a clearance fit into staking pin holes formed in the end plates and the rotor core, the staking pins are formed by staking to fasten the rotor core with the end plates. Then, by making the difference between the outer diameter of the rotor core (laminated iron core) and the outer diameter of the end plates (or the difference between the inside diameter of the rotor core and the inside diameter of the end plates) larger than the sum of the difference between the diameter of the staking pins and the diameter of the staking pin holes of the rotor core and the difference between the diameter of the staking pins and the diameter of the staking pin holes of the end plates, the outer peripheries of the end plates are prevented from flying out of the outer periphery of the rotor core even when a deviation in the fastening position occurs between the rotor core and the end plates, so that the electric motor is configured not to bring the rotor into contact with a stator.

### PRIOR ART DOCUMENT

### Patent Document

Patent Document 1: JP2009-112089 A

### SUMMARY OF THE INVENTION

### Problem to be Solved by the Invention

However, in the rotor of the electric motor described in Patent Document 1, due to clearances existing respectively between the rotor core and the staking pins and between the end plates and the staking pins, an anxiety arises in that the rotor core and the end plates deviate relative to the staking pins by the action of a centrifugal force and the like resulting from the rotation of the rotor. Therefore, there arises an anxiety that the rotor becomes unstable in rotation. Further, there arises an anxiety that a fault like the contact between the rotor and the stator occurs unless accurate control is made of the difference between the outer diameter of the rotor core and the outer diameter of the end plates, the difference between the diameter of the staking pins and the staking pin holes of the rotor core and the difference between the diameter of the staking pins and the staking pin holes of the end plates.

In addition, because for fastening with staking pins of this kind, usually, heads of the staking pins are pressed by flat punches to be formed by staking, the area to be formed becomes large to require an increased forming load. Thus, in the case of a staking needing large-diameter staking pins, an anxiety arises in that an increase in the forming load causes the rotor core to be deformed, thereby deteriorating the rotor in accuracy.

The present invention has been made with the foregoing problems taken into consideration, and an object thereof is to provide a rotor of an electric motor and a manufacturing method thereof being capable of performing a fastening by an accurate staking while restraining the deformation of the rotor by enabling the staking to be done with a small forming load.

### Measures for Solving the Problems

In order to solve the aforementioned problems, the feature of the invention in a first aspect resides in a rotor of an electric motor receiving permanent magnets therein, the rotor comprising a rotor core composed of laminated steel plates and having pin holes; a pair of end plates having insertion holes of a diameter being greater than or equal to a diameter of the pin holes of the rotor core and arranged on opposite sides of the rotor core; and fastening members inserted into the pin holes of the rotor core, fitted in the insertion holes of the pair of end plates, and pressed by staking at opposite end portions thereof, each fastening member having a body portion, main-radially expanded portions continued from the body portion and being larger in diameter than the insertion holes of the end plates, and protrusions continued from the main radially-expanded portions and protruding from the main radially-expanded portions.

The feature of the invention in a second aspect resides in a manufacturing method for a rotor of an electric motor with end plates arranged on opposite sides of a rotor core composed of laminated steel plates, the manufacturing method for the rotor of an electric motor comprising a step of inserting fastening members into pin holes formed in the rotor core, through insertion holes formed in the end plates; and a step of pressing and forming opposite end surfaces of the inserted fastening members by staking punches so that each fastening member is formed at opposite end portions thereof with main radially-expanded portions being larger in diameter than the insertion holes of the end plates and protrusions continued from the main radially-expanded portions and protruding from the main radially-expanded portions.

### BRIEF DESCRIPTION OF THE DRAWINGS

FIG. 1 is a sectional view of a hybrid vehicle drive unit showing an embodiment of the present invention.

FIG. 2 is a view showing a rotor of an electric motor.

FIGS. 3(A)-3(C) are views showing a manufacturing method for the rotor of the electric motor according to a first embodiment of the present invention.

FIGS. 4(A)-4(B) are views showing a manufacturing method for the rotor of the electric motor according to a second embodiment of the present invention.

### FORM FOR PRACTICING THE INVENTION

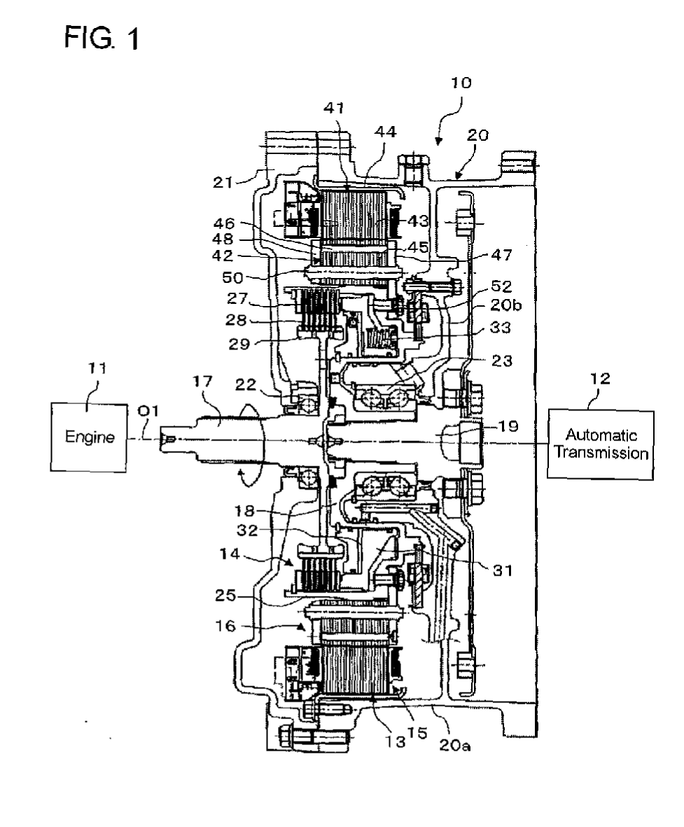

Hereinafter, embodiments of the present invention will be described with reference to drawings. FIG. 1 shows an example in which a rotor of an electric motor manufactured by the methods of the present invention is applied to a hybrid vehicle drive unit 10. The hybrid vehicle drive unit 10 is arranged between an engine 11 of the vehicle and an automatic transmission 12 and has an electric motor 13 and a clutch device 14. The electric motor 13 is composed of a stator 15 and a rotor 16. The rotor 16 is in connection to an input shaft 17 coupled to the engine 11, through the clutch device 14 to be disconnectable therefrom, and the rotation of the rotor 16 is transmitted to the input shaft 17 through the clutch device 14. Further, the rotor 16 of the electric motor 13 is connected with an output shaft 18, which is coupled to a center piece 19 constituting an input shaft of the automatic transmission 12. The automatic transmission 12 is provided with a torque converter and a transmission (both not shown), and the output of the torque converter is transmitted to driving wheels for the vehicle through the transmission.

The hybrid vehicle drive unit 10 has a housing 20 surrounding the electric motor 13 and the clutch device 14. The housing 20 has a peripheral wall portion 20a forming the outer shape and a rear sidewall portion 20b interposed between the electric motor 13 and the clutch device 14 and the automatic transmission 12 and opens on the engine 11 side.

On the engine 11 side of the housing 20, there is arranged a front housing 21 which forms a cover portion closing an opening portion of the housing 20. The front housing 21 is secured to the housing 20 by means of bolts. A through hole with the input shaft 17 passing therethrough is provided at the center portion of the front housing 21. The input shaft 17 is supported by a ball bearing 22 arranged at the center portion, rotatably about a rotational axis O1 thereof.

The rear sidewall portion 20b of the housing 20 is provided at a center portion thereof with a through hole allowing the output shaft 18 to pass therethrough. The output shaft 18 is supported by a ball bearing 23 arranged at the center portion, rotatably about the rotational axis O1. The center piece 19 of the automatic transmission 12 is rotationally connected to the output shaft 18 coaxially with the same.

The output shaft 18 roughly takes a numeral “3” or double-hook shape in the section taken along the rotational axis and is formed with a clutch drum portion 25 at the outer circumferential part thereof. The rotor 16 of the electric motor 13 is arranged on the outer circumference of the clutch drum portion 25. A plurality of outer clutch plates 27 each taking an annular shape are engaged with an internal surface of the clutch drum portion 25 to be restricted in relative rotation and to be movable in the rotational axis direction. A plurality of inner clutch plates 28 each taking an annular shape are arranged at respective spaces between the outer clutch plates 27. These inner clutch plates 28 are in engagement with the outer circumference of a clutch hub portion 29 protruding from the outer circumference of the input shaft 17 to be restricted in relative rotation and to be movable in the rotational axis direction.

The output shaft 18 is formed therein with a cylinder 32 in which a piston 31 is slidably fitted. By the urging force of coil springs 33, the piston 31 presses the outer clutch plates 27 in the direction to bring the same into contact with the inner clutch plates 28. Further, the piston 31 is slidden by the pressurized fluid supplied to the cylinder 32, against the urging force of the coil springs 33 to release the junction between the outer clutch plates 27 and the inner clutch plates 28.

The clutch device 14 is composed of the outer clutch plates 27, the inner clutch plates 28, the piston 31, the cylinder 32, the coil springs 33 and the like all aforementioned.

Next, the electric motor 13 will be described. The electric motor 13 is constituted by a brushless DC motor or the like and is arranged between the internal circumference of the peripheral wall portion 20a of the housing 20 and the outer circumference of the clutch drum portion 25 of the output shaft 18. The electric motor 13 is provided with a stator core 41 constituting the stator 15 and a rotor core 42 constituting the rotor 16, and the rotor core 42 is rotatably supported in the housing 20 inside the stator core 41. The stator core 41 is composed of a plurality of steel plates 43 laminated in the axial direction of the input shaft 17. The stator core 41 is constituted by a plurality of core segments that are arranged annularly to be integrated, and is tightly fitted by press-fitting or the like into a core holder 44 fixed to the internal circumference of the peripheral wall portion 20a of the housing 20. It is to be noted that although not shown, a coil is wounded around each of the core segments.

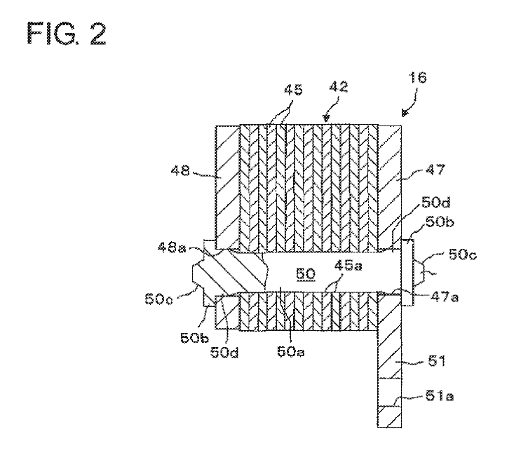

As shown in FIG. 2 in detail, the rotor core 42 constituting the rotor 16 of the electric motor 13 is composed of the plurality of steel plates 45 laminated in the axial direction of the input shaft 17. A plurality of permanent magnets 46 (refer to FIG. 1) are embedded in the rotor core 42 to be arranged in the circumferential direction. At the opposite end portions in the axial direction of the rotor core 42, a pair of end plates 47, 48 are arranged to put the rotor core 42 therebetween, and these end plates 47, 48 prevent the permanent magnets 46 from flying out of the rotor core 42. The rotor core 42 and the end plates 47, 48 are integrally fastened by a plurality of staking pins 50 as fastening members arranged in the circumferential direction, as described later, so that an assembly of the rotor 16 is constructed.

The end plate 47 on one side has an extension portion 51 extending radially inward, and bolt insertion holes 51a are formed in the extension portion 51. The end plate 47 is fixed by bolts 52 (refer to FIG. 1) inserted into the bolt insertion holes 51a, to an end surface of the output shaft 18. Therefore, the rotor 16 (the rotor core 42) of the electric motor 13 and the output shaft 18 are integrally rotated.

A plurality of pin holes 45a into which the staking pins 50 are inserted are formed by punching in the plurality of laminated steel plates 45 constituting the rotor core 42, to be arranged in the circumferential direction. The inside diameter of the pin holes 45a of the laminated steel plates 45 is formed to be almost the same diameter as the outside diameter of the staking pins 50. The staking pins 50 are inserted into the pin holes 45a through a transition fit, that is, the transition fit being between a clearance fit and an interference fit, so that the pin holes 45a of the laminated steel plates 45 (rotor core 42) and the staking pins 50 are fitted without a clearance therebetween.

Further, in the pair of end plates 47, 48, pluralities of insertion holes 47a, 48a arranged in the circumferential direction and having a diameter which is greater than or equal to the diameter of the pin holes 45a formed in the rotor core 42 (laminated steel plates 45) are formed in the same phases as the pin holes 45a of the rotor core 42. Opposite end portions of the staking pins 50 are fitted in these insertion holes 47a, 48a tightly without a clearance through a radial expansion step referred to later. The opposite end portions of each staking pin 50 are formed by staking to be fastened integrally to the end plates 47, 48. As a result, the rotor core 42 put and held between the end plates 47, 48 is integrally fastened to the staking pins 50 and the end plates 47, 48.

That is, as shown in FIG. 2, each staking pin (fastening member) 50 has a body portion 50a inserted into the rotor core 42, main radially-expended portions 50b, 50b continued from opposite end portions of the body portion 50a and being larger in diameter than the insertion holes 47a, 48a of the end plates 47, 48, and taper-shaped protrusions 50c, 50c continued from the main radially-expanded portions 50b, 50b and protruding from the main radially-expanded portions 50b, 50b. Further, the body portion 50a has subordinate radially-expanded portions 50d, 50d being smaller in diameter than the main radially-expanded portions 50b, 50b, and the subordinate radially-expanded portions 50d, 50d are arranged in the insertion holes 47a, 48a of the end plates 47, 48 without a clearance.

In this way, the main radially-expanded portions 50b, 50b are engaged with the end surfaces of the end plates 47, 48, and the subordinate radially-expanded portions 50d, 50d are tightly fitted in the insertion holes 47a, 48a of the end plates 47, 48, so that the rotor core 42, the end plates 47, 48 and the staking pins 50 can be restrained from deviating in mutual position even if a centrifugal force acts during the rotation of the rotor 16. Further, since the protrusions 50c, 50c of each staking pin 50 take a taper shape, it becomes easier to pull out staking punches 80A, 80B, referred to later, from the protrusions 50c, 50c after the staking is performed by the staking punches 80A, 80B.

The rotor core 42 is constituted by a plurality of core segments that are divided in the circumferential direction in the same manner as is done with the stator core 41, and the laminated steel plates 45 constituting each core segment are fastened to the end plates 47, 48 by a plurality of staking pins 50. In advance of being fastened by the staking pins 50, the plurality of laminated steel plates 45 are subjected to a staking that forms well-known dowels or joggles between the plurality of pin holes 45a, with the respective pin holes 45 aligned in phase and thus, are positioned temporarily.

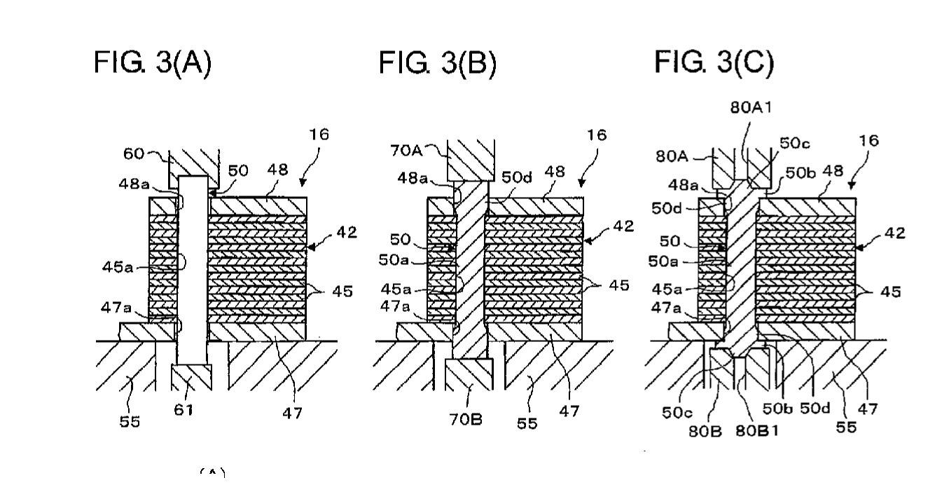

Next, description will be made regarding a method of manufacturing the aforementioned rotor 16 of the electric motor 13. FIGS. 3(A)-3(C) show the manufacturing method for the rotor 16 of the electric motor 13 in a first embodiment.

The rotor core 42 temporarily positioned by the dowel forming staking to make the pin holes 45a in the plurality of laminated steel plates 45 agree in phase has the permanent magnets 46 embedded therein. After this, the rotor core 12 is stacked on the end plates 47, 48 on opposite sides thereof so that the insertion holes 47a, 48a formed in the end plates 47, 48 are brought into agreement with the pin holes 45a of the rotor core 42, and then, is positioned inside a die 55 in a horizontal state.

In this state, first of all, at an “insertion step” shown in FIG. 3(A), the plurality of staking pins 50 arranged in the circumferential direction are lowered by insertion punches 60 from the insertion hole 48a side of the end plate 48 on one side to a position where to contact stoppers 61. Thus, as shown in FIG. 3(A), the boy portions 50a of the staking pins (fastening members) 50 are inserted respectively into the plurality of pin holes 45a arranged in the rotor core 42 (laminated steel plates 45) in the circumferential direction. In this case, the insertions of the staking pins 50 into the pin holes 45a of the rotor core 42 can be performed naturally through a transition fit between a clearance fit and an interference fit without a clearance between the staking pins 50 and the pin holes 45a and without deforming the laminated steel plates 45. The both end portions of the staking pins 50 having been inserted into the rotor core 42 are in the state that they fit in the insertion holes 47a, 48a of the end plates 47, 48 loosely with a slight clearance relative to the insertion holes 47a, 48a and that they protrude a predetermined amount from the opposite end surfaces of the end plates 47, 48.

Then, the die 55 positioning the rotor core 42 is indexed to an “expansion step” in FIG. 3 (B). At this “expansion step”, the opposite end surfaces of the staking pins 50 are pressed by expansion punches 70A, 70B that are flat at end surfaces thereof. Thus, as shown in FIG. 3 (B), the opposite end portions of the staking pins 50 that loosely fit in the insertion holes 47a, 48a of the end plates 47, 48 are expanded in diameter to form subordinate radially-expanded portions 50d, 50d. As a result, these subordinate radially-expanded portions 50d, 50d are tightly fitted in the insertion holes 47a, 48a of the end plates 47, 48 without a clearance.

Thereafter, the die 55 positioning the rotor core 42 is indexed to a “staking step” shown in FIG. 3 (C). At this “staking step”, the opposite end surfaces of the staking pins 50 are pressed by staking punches 80A, 80B each being flat at an end surface thereof and each taking a hollow shape. The staking punches 80A, 80B are sufficiently larger in the diameter at the end surfaces than the diameter of the expanded subordinate radially-expanded portions 50d, 50d of the staking pins 50 and have hollow holes 80A1, 80B1 that are sufficiently smaller in diameter than the diameter of the subordinate radially-expanded portions 50d, 50d. It is to be noted that opening ends of the hollow holes 80A1, 80B1 are formed to a taper shape which expands in diameter toward the end surface.

By being pressed by the staking punches 80A, 80B of the hollow shape, the opposite end portions of the staking pins 50 are formed by staking to protrude radially outward from the insertion holes 47a, 48a of the end plates 47, 48, as shown in FIG. 3 (C). That is, as a result that the opposite end portions of the staking pins 50 are expanded in diameter, there are formed main radially-expanded portions 50b, 50b which engage with the opposite end surfaces of the end plates 47, 48. As a result of the staking, parts in thickness of the opposite end portions of the staking pins 50 flow into the hollow holes 80A1, 80B1 of the staking punches 80A, 80B, whereby protrusions 50c of a taper shape protruding from the main radially-expanded portions are formed at the opposite end portions of the staking pins 50.

In this way, the rotor core 42 and the pair of end plates 47, 48 are integrally fastened by the staking pins 50, so that the rotor 16 of the electric motor 13 is manufactured. As shown in FIG. 1, the manufactured rotor 16 is supported inside the stator 15 of the electric motor 13 with a predetermined space and is secured to the output shaft 18 by the bolts 52.

In the hybrid vehicle drive unit 10 as constructed above, when the driver steps on an accelerator pedal (at a small opening degree of throttle) after turning an ignition switch (not shown) to ON in the stop state of the vehicle, the electric current flows from a battery (not shown) to the electric motor 13, and thus, the electric motor 13 acts as driving motor. Then, the rotational driving force is transmitted to the torque converter through the output shaft 18, is increased by the torque converter at a predetermined torque ratio, and is transmitted to the driving wheels through the transmission.

At the time of the starting of the vehicle, the engine 11 is in a stop state as a fuel injection system of the engine 11 does not operate. Thus, the vehicle starts by the driving force only from the electric motor 13. At this time, the clutch device 14 is out of engagement. Further, in a range that the engine efficiency is low such as the time of the load to the engine being low or very low, the engine 11 remains stopped, and the traveling is given by the electric motor 13 only with the clutch device 14 held out of engagement.

Further, even if the speed is relatively low because the vehicle is just after a starting, the engine 11 is started at the time of an acceleration or a hill climbing. That is, when for an accelerating or a hill climbing, the accelerator pedal is stepped on to open the throttle to a predetermined opening degree or more, the fuel injection system is operated, the ignition plug is ignited, and an output shaft of a starter motor (not shown) secured to the housing 20 is driven, whereby the engine 11 is started. At this time, since the clutch device 14 is brought into engagement, the rotational driving force of the input shaft 17 is transmitted to the output shaft 18 through the clutch device 14. In this way, both driving forces of the engine 11 and the electric motor 13 are added, whereby the vehicle travels with a large driving force. Then, when the vehicle is in a traveling state at usual high speeds, the electric motor 13 is placed under a no-load running (in which the motor output is controlled to offset the torque generated by a counter electromotive force produced in the electric motor), whereby the electric motor 13 runs idle. Consequently, with the clutch devices 14 remaining engaged, the vehicle travels mainly by the driving force only of the engine 11.

The rotor 16 of the electric motor in the foregoing first embodiment is provided with the rotor core 42 composed of the laminated steel plates 45 having the pin holes 45a; the pair of end plates 47, 48 having the insertion holes 47a, 48a being larger in diameter than the pin holes 45a of the rotor core 42 and arranged on the opposite end sides of the rotor core 42; and the fastening members (staking pins) 50 inserted into the pin holes 45a of the rotor core 42 through the transition fit, fitted in the insertion holes 47a, 48a of the pair of end plates 47, 48, and pressed by staking at the opposite ends thereof, wherein each fastening member has the body portion 50a, the main radially-expanded portions 50b, 50b continued from the body portion 50a and being larger in diameter than the insertion holes 47a, 48a of the end plates 47, 48, and the protrusions 50c, 50c continued from the main radially-expanded portions 50b, 50b and protruding form the main radially-expanded portions 50b, 50b.

Thus, it does not occur that the laminated steel plates 45 are deformed by the insertions of the fastening members 50 into the pin holes 45a of the rotor core 42. In addition, since the fastening members 50 are tightly fitted into the rotor core 42 and the pair of end plates 47, 48 without a clearance, it is possible to restrain the rotor core 42 and the end plates 47, 48 from being deviated in position by the action of a centrifugal force or the like resulting from the rotation of the rotor 16.

Furthermore, according to the manufacturing method for the rotor 16 of the electric motor in the first embodiment, the “insertion step”, the “expansion step” and the “staking step” are performed separately, so that it becomes possible at the “insertion step” to naturally insert the fastening members 50 into the pin holes 45a of the rotor core 42 without deforming the laminated steel plates 45 and without providing a clearance therebetween Further, since the subordinate radially-expanded portions 50d, 50d are formed at the “expansion step”, it is possible to eliminate a clearance between each fastening member 50 and the end plates 47, 48 and it becomes possible to perform the “staking step” with a small forming load. Therefore, it becomes possible to manufacture the rotor 16 accurately while suppressing the deformation of the rotor 16 of the electric motor 13.

Although in the manufacturing method in the foregoing first embodiment, description has been made taking an example that the rotor core 42 side is indexed in turn to the “insertion step”, the “expansion step” and the “staking step”, it may also be possible to provide the part of the insertion punches 60, the expansion punches 70 and the staking punches 80 to be indexable and to manufacture the rotor 16 with the rotor core 42 held stationarily inside the die 55.

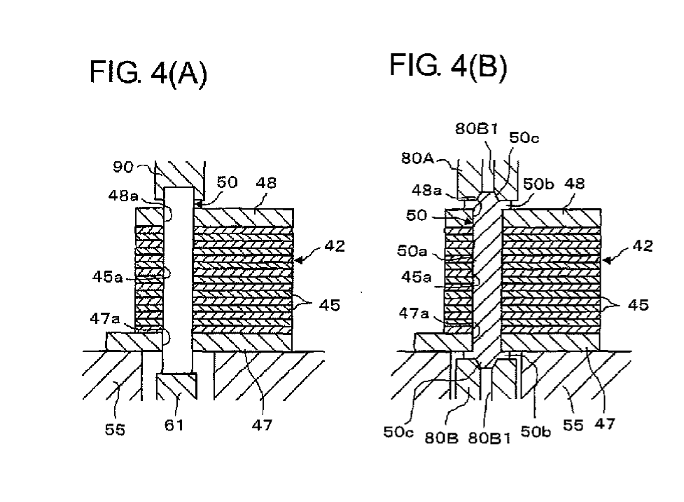

FIGS. 4(A)-4(B) show a manufacturing method for the rotor 16 of the electric motor 13 in a second embodiment. The difference from the first embodiment resides in that the “insertion step” and the “expansion step” are defined collectively as “press-fitting step” and that the rotor 16 of the electric motor 13 can be manufactured through two steps of the “press-fitting step” and the “staking step”. Hereinafter, differences from the first embodiment will be described mainly, and the same components will be given the same reference numerals and will be omitted from description.

In the second embodiment, the insertion holes 47a, 48a formed in the pair of end plates 47, 48 are made to be larger in diameter than the diameter of the pin holes 45a of the rotor core 42 similarly as described in the first embodiment. However, the difference in diameter is made to be small in comparison with the case of the first embodiment.

In the second embodiment, first of all, at the “press-fitting step” shown in FIG. 4 (A), the plurality of staking pins (fastening members) 50 arranged in the circumferential direction are lowered by press-fitting punches 90 from the insertion holes 48a side of the end plate 48. Thus, the staking pins 50 are press-fitted into the insertion holes 48a of the end plate 48 through an interference fit, are inserted into the pin holes 45a of the rotor core 42 through a transition fit, and are inserted into the insertion holes 47a of the end plate 47 through an interference fit.

After the staking pins 50 are press-fitted by the press-fitting punches 90 to the predetermined position, then at the “staking step” shown in FIG. 4 (B), the opposite end surfaces of the staking pins 50 are pressed by the staking punches 80A, 80B being flat and taking a hollow shape. By being pressed by the staking punches 80A, 80B, the opposite end surfaces of the staking pins 50 are formed to protrude radially outward from the insertion holes 47a, 48a of the end plates 47, 48, as shown in FIG. 4 (B), whereby the main radially-expanded portions 50b, 50b are formed and the protrusions 50c of the taper shape protruding from the main radially-expanded portions are formed.

According to the manufacturing method for the rotor 16 of the electric motor 13 in the foregoing second embodiment, it is possible to perform the same operations and effects as described in the foregoing first embodiment and at the same time, to realize a decrease in manufacturing step.

Further, as a modified form in the foregoing first and second embodiments, it is possible to omit the “expansion step” in the first embodiment by enabling the opposite end portions of the staking pins 50 to be expanded radially at the “staking step” and to manufacture the rotor 16 of the electric motor 13 through two steps of the “insertion step” and the “staking step”.

Although the foregoing embodiment has been described taking an example that the rotor 16 of the electric motor 13 is applied to the hybrid vehicle drive unit 10, the present invention may be applied to the rotors 16 of the electric motors 13 in a wide variety of the type that the rotor core 42 composed of the laminated steel plates 45 and the end plates 47, 48 are fastened by the staking pins 50.

Although the foregoing embodiment has been described taking an example that the fastening members (staking pins) 50 are inserted into the pin holes 45a of the rotor core 42 through the transition fit, a clearance fit giving a slight clearance may be used and may suffice if the rotor core 42 can be substantially restrained from being deviated relative to the fastening members 50 by the action of a centrifugal force or the like.

Further, although in the foregoing embodiments, the opposite end surfaces of the fastening members 50 are pressed by the hollow staking punches 80A, 80B, the staking punches 80A, 80B suffice to be those capable of forming, by staking, the opposite end surfaces of the fastening members 50 to a protrusion shape.

Various features and many of the attendant advantages in the foregoing embodiments will be summarized as follows:

According to the rotor of an electric motor in the embodiment typically shown in FIGS. 1 and 2, since the rotor 16 comprises the rotor core 42 composed of the laminated steel plates 45 and having the pin holes 45a; the pair of end plates 47, 48 having the insertion holes 47a, 48a of the diameter being greater than or equal to the diameter of the pin holes 45a of the rotor core 42 and arranged on the opposite sides of the rotor core 42; and the fastening members 50 inserted into the pin holes 45a of the rotor core 42, fitted in the insertion holes 47a, 48a of the pair of end plates 47, 48, and pressed by staking at opposite ends thereof, each fastening member 50 having the body portion 50a, the main-radially expanded portions 50b, 50b being larger in diameter than the insertion holes 47a, 48a of the end plates 47, 48 and the protrusions 50c, 50c protruding from the main radially-expanded portions 50b, 50b, it is possible to insert the fastening members 50 into the pin holes 45a of the rotor core 42 without deforming the laminated steel plates 45. In addition, since the opposite end portions of the fastening members 50 are formed by staking to a protrusion shape, it is possible to accomplish the staking by a small forming load and hence, to obtain an accurate rotor as a result of suppressing the deformation of the rotor 16.

According to the rotor of an electric motor in the embodiment typically shown in FIGS. 1 and 2, since the fastening members 50 are tightly fitted in the insertion holes 47a, 48a of the end plates 47, 48, it is possible to make insertions not to provide clearances between the rotor core 42, the fastening members 50 and the end plates 47, 48, and hence, to restrain the rotor core 42 and the end plates 47, 48 from being deviated in position by the action of a centrifugal force or the like resulting form the rotation of the rotor 16.

According to the rotor of an electric motor in the embodiment typically shown in FIGS. 2, 3(C) and 4(B), since the protrusions 50c, 50c take a taper shape, it becomes easier to pull out the staking punches 80A, 80B from the protrusions 50c, 50c at the time of assembling the rotor 16 by the fastening members 50.

According to the rotor of an electric motor in the embodiment typically shown in FIG. 2, since the body portion 50a has the subordinate radially-expanded portions 50d, 50d being smaller in diameter than the main radially-expanded portions 50b, 50b and since the subordinate radially-expanded portions 50d, 50d are arranged in the insertion holes 47a, 48a of the end plates 47, 48, it is possible to fit the subordinate radially-expanded portions 50d, 50d in the insertion holes 47a, 48a of the end plates 47, 48 without a clearance therebetween by subjecting the fastening members 50 to the staking.

According to the manufacturing method for the rotor of an electric motor in each of the embodiments respectively shown in FIGS. 3(A)-3(C) and 4(A)-4(B), since the method comprises the step of inserting the fastening members 50 into the pin holes 45a formed in the rotor core 42, through the insertion holes 47a, 48a formed in the end plates 47, 48 and the step of pressing and forming the opposite end surfaces of the inserted fastening members 50 by the staking punches 80A, 80B so that each fastening member 50 is formed at the opposite end portions thereof with the main radially-expanded portions 50b, 50b being larger in diameter than the insertion holes 47a, 48a of the end plates 47, 48 and the protrusions 50c, 50c protruding from the main radially-expanded portions 50b, 50b, it is possible to insert the fastening members 50 without providing a clearance between the fastening members 50 and the rotor core 42 at the step of inserting the fastening members 50. In addition, since the step using the staking punches 80A, 80B can be done with a small forming load, it is possible to manufacture the rotor 16 accurately as a result of suppressing the deformation of the rotor 16.

According to the manufacturing method for the rotor of an electric motor in the embodiment shown in FIGS. 3(A)-3(C), since the method further comprises the step of pressing the opposite end surfaces of the fastening members 50 having been inserted into the pin holes 45a of the rotor core 42 to expand the diameters of the opposite end portions of the fastening members 50 so that the fastening members 50 are fitted in the insertion holes 47a, 48a of the end plates 47, 48 without a clearance therebetween, it is possible to easily insert the fastening members 50 into the pin holes 45a of the rotor core 42 and to easily fit the fastening members 50 in the insertion holes 47a, 48a of the end plates 47, 48.

According to the manufacturing method for the rotor of an electric motor in each of the embodiments respectively shown in FIGS. 3(A)-3(C) and 4(A)-4(B), since the protrusions 50c, 50c take a taper shape, it becomes easer to pull out the staking punches 80A, 80B from the protrusions 50c, 50c of the respective fastening members 50.

Although the embodiments of the present invention have been described hereinabove, the present invention is not limited to the foregoing embodiments and may be modified to various forms without departing from the gist of the present invention as described in the claims.

### INDUSTRIAL APPLICABILITY

A rotor of an electric motor and a manufacturing method thereof according to the present invention are suitable for use in fastening a rotor core constituted by a laminated iron core by fastening members.

1-7. (canceled)

8. A rotor of an electric motor receiving permanent magnets therein, the rotor comprising;
a rotor core composed of laminated steel plates and having pin holes;
a pair of end plates having insertion holes of a diameter being greater than or equal to a diameter of the pin holes of the rotor core and arranged on opposite sides of the rotor core; and fastening members inserted into the pin holes of the rotor core, fitted in the insertion holes of the pair of end plates, and pressed by staking at opposite end portions thereof, each fastening member having a body portion, main-radially expanded portions continued from the body portion and being larger in diameter than the insertion holes of the end plates, and protrusions continued from the main radially-expanded portions and protruding from the main radially-expanded portions.

9. The rotor of an electric motor described in claim 8, wherein the fastening members are tightly fitted in the insertion holes of the end plates.

10. The rotor of an electric motor described in claim 8, wherein the protrusions take a taper shape.

11. The rotor of an electric motor described in claim 8, wherein the body portion has subordinate radially-expanded portions being smaller in diameter than the main radially-expanded portions and wherein the subordinate radially-expanded portions are arranged in the insertion holes of the end plates.

12. A manufacturing method for a rotor of an electric motor with end plates arranged on opposite sides of a rotor core composed of laminated steel plates, the method comprising:
a step of inserting fastening members into pin holes formed in the rotor core through insertion holes formed in the end plates; and
a step of pressing and forming opposite end surfaces of the inserted fastening members by staking punches so that each fastening member is formed at opposite end portions thereof with main radially-expanded portions being larger in diameter than the insertion holes of the end plates and protrusions continued from the main radially-expanded portions and protruding from the main radially-expanded portions.

13. The manufacturing method for the rotor of an electric motor described in claim 12, the method further comprising:
a step of pressing the opposite end surfaces of the fastening members having been inserted into the pin holes of the rotor core to expand diameters of the opposite end portions of the fastening members so that the fastening members are fitted in the insertion holes of the end plates without a clearance therebetween.

14. The manufacturing method for the rotor of an electric motor in claim 12, wherein the protrusions take a taper shape.
